(19) United States
(12) Patent Application Publication
(10) Pub. No.: US 2026/0169196 A1
(43) Pub. Date: Jun. 18, 2026

(54) OPTICAL ELEMENT, OPTICAL EQUIPMENT, IMAGE PICKUP APPARATUS, AND METHOD OF MANUFACTURING OPTICAL ELEMENT

(71) Applicant: CANON KABUSHIKI KAISHA, Tokyo (JP)

(72) Inventors: MAMO MATSUMOTO, Kanagawa (JP); HIDEO UKUDA, Kanagawa (JP)

(21) Appl. No.: 19/409,878

(22) Filed: Dec. 5, 2025

(30) Foreign Application Priority Data
Dec. 12, 2024 (JP) 2024-217349
Dec. 26, 2024 (JP) 2024-230862

(51) Int. Cl. G02B 1/111; G02B 1/118; G02B 1/14; H04N 23/51; H04N 23/55

(52) U.S. Cl. CPC G02B 1/111; G02B 1/118; G02B 1/14; H04N 23/55; H04N 23/51

(57) ABSTRACT

To provide an optical element having environmental durability, provided is an optical element including: a substrate; a resin layer arranged on the surface of the substrate so as to have a diameter smaller than the diameter of the substrate; an antireflection film configured to cover at least a boundary part between the substrate and the resin layer; and a protective layer, wherein the antireflection film includes a porous layer containing inorganic compound particles, and the protective layer is arranged on the boundary part.

### BACKGROUND

### Field of the Technology

The present disclosure relates to an optical element, optical equipment, an image pickup apparatus, and a method of manufacturing an optical element.

### Description of the Related Art

A lens in which a cured product of a resin composition is arranged on a transparent substrate such as glass has been known as one of optical elements. Such lens is manufactured with use of a mold by polymerizing or copolymerizing a resin composition arranged between a substrate and the mold to form a cured product having a desired shape on a surface of the substrate. A lens manufactured by such manufacturing method is called a replica element.

The replica element has involved a problem with the environmental durability of its lens because when the element is used in a low-temperature environment, its antireflection film may peel off.

Meanwhile, there has hitherto been known a method of reducing internal reflection due to unrequired light by forming a light-shielding film on an edge portion of the lens for the purpose of improving the appearance quality of the replica element.

In Japanese Patent No. 3670027, there is disclosed, as an example of the replica element, an aspherical lens molded so that the edge surface of the outermost perimeter of the cured product of the resin composition is covered with a light-shielding film.

### SUMMARY

However, the optical element disclosed in Japanese Patent No. 3670027 aims at improving appearance quality, and its antireflection film may still peel off when the optical element is used in a low-temperature environment. Accordingly, there has been a problem in that the durability of the lens reduces depending on an environment.

The present disclosure is directed to providing an optical element having excellent durability in various environments and a method of manufacturing the optical element.

An optical element according to one aspect of the present disclosure is an optical element including: a substrate; a resin layer arranged on a surface of the substrate so as to have a diameter smaller than a diameter of the substrate; an antireflection film configured to cover at least a boundary part between the substrate and the resin layer; and a protective layer, wherein the antireflection film includes a porous layer containing inorganic compound particles, and the protective layer is arranged on the boundary part.

A method of manufacturing an optical element according to another aspect of the present disclosure includes: a filling step of filling a space between a substrate and a mold with a resin composition; a curing step of curing the resin composition to form the resin layer; a mold release step of releasing the resin layer from the mold; an antireflection film-forming step of forming an antireflection film on a surface of the resin layer; and a light-shielding film-forming step of forming a light-shielding film configured to cover part of the antireflection film.

Features of the present disclosure will become apparent from the following description of embodiments with reference to the attached drawings. The following description of embodiments is described by way of example.

### BRIEF DESCRIPTION OF THE DRAWINGS

FIG. 1 is a schematic view for illustrating an optical element according to a first embodiment of the present disclosure.

FIG. 2A is a schematic view for describing the antireflection film of the optical element according to the first embodiment of the present disclosure.

FIG. 2B is a schematic view for describing an example in which the antireflection film of the optical element according to the first embodiment of the present disclosure includes a plurality of layers.

FIG. 3 is a schematic view for illustrating a modified example of the optical element according to the first embodiment of the present disclosure.

FIG. 4A is a view for illustrating an example of a method of manufacturing the optical element according to the first embodiment of the present disclosure.

FIG. 4B is a view for illustrating an example of a method of manufacturing the modified example of the optical element according to the first embodiment of the present disclosure.

FIG. 5 is a schematic view for describing an example of the method of manufacturing the optical element according to the first embodiment of the present disclosure.

FIG. 6 is a schematic view for illustrating an image pickup apparatus according to a second embodiment of the present disclosure.

### DESCRIPTION OF THE EMBODIMENTS

### First Embodiment

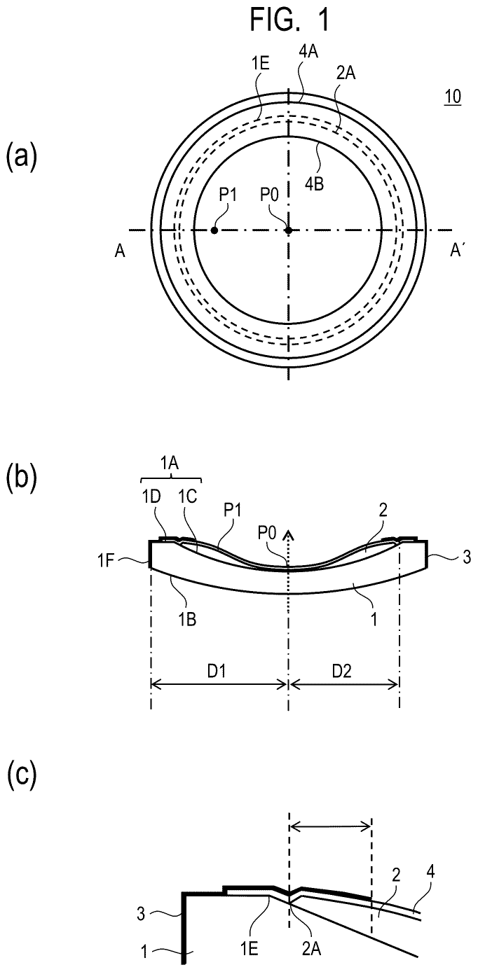

An optical element according to a first embodiment of the present disclosure and a method of manufacturing the optical element are described with reference to FIG. 1.

First, the configuration of the optical element according to this embodiment is described with reference to FIG. 1. FIG. 1 is a schematic view for illustrating the configuration of an optical element 10 according to this embodiment.

(a) of FIG. 1 is a top view of the optical element 10. (b) of FIG. 1 is a sectional view in a thickness direction taken along the line A-A′ in (a) of FIG. 1. (c) of FIG. 1 is a sectional view for illustrating part of the optical element 10 in an enlarged manner.

The optical element 10 according to this embodiment is a replica lens. As illustrated in each of FIG. 1, the optical element 10 according to this embodiment includes a substrate 1 and a resin layer 2 that is a cured product of a resin composition formed on the substrate 1. In this embodiment, the substrate 1 may be a transparent glass substrate.

The resin layer 2 is arranged in close contact with the top of a first surface 1A of the substrate 1 so as to have a diameter D2 that is smaller than a diameter D1 of the substrate 1. The thickness of the resin layer 2 in an optical axis direction (the direction indicated by the arrow in (b) of FIG. 1) is not uniform in the radial direction of the optical element 10, but has a non-uniform distribution in the surface thereof. Thus, an aspherical shape is imparted to the surface of the resin layer 2.

The optical element 10 according to this embodiment is formed as an aspherical lens including the resin layer 2, and hence can be manufactured with labor less than that of an aspherical lens formed only of glass. Accordingly, according to this embodiment, the aspherical lens can be manufactured at low cost.

The substrate 1 includes: the first surface 1A including an optical surface 1C that is a spherical surface and a flat surface 1D; and a second surface 1B facing the first surface. The optical surface 1C has a concave spherical shape, and the second surface 1B has a convex spherical shape. The flat surface 1D is arranged so as to be connected to the optical surface 1C by surrounding the optical surface 1C via a ridge line 1E. That is, the first surface 1A includes the optical surface 1C, the flat surface 1D arranged on the outer edge of the optical surface 1C, and the ridge line 1E serving as a boundary line between the optical surface 1C and the flat surface 1D. The second surface 1B is one of an incident surface or an exit surface for light in the optical element 10. In the figure, the outer end portion of an antireflection film is represented by reference symbol 4A, and the inner end portion of a protective layer is represented by reference symbol 4B.

In addition, in the optical element 10, the distal end of the resin layer 2 has a boundary part 2A serving as a boundary between the substrate 1 and the resin layer, and the element includes an antireflection film 4 covering at least the boundary part 2A. Thus, reflection at the light incidence surface or light exit surface of the element is suppressed.

When the replica lens is subjected to an abrupt temperature change, the antireflection film 4 may peel off the surface of the resin layer 2. This is assumed to result from the following: along with the abrupt thermal expansion and thermal contraction of the resin layer 2, the antireflection film 4 cannot follow a change in shape of the resin layer 2, and hence a crack occurs in the antireflection film 4, particularly in the boundary part 2A; and as a result of the occurrence, the film peeling of the antireflection film 4 develops from the crack serving as a starting point.

Accordingly, in the present disclosure, the antireflection film 4 includes a porous layer containing at least inorganic compound particles, and a protective layer 3 is arranged on the surface of the antireflection film 4 located in the boundary part 2A. When the antireflection film 4 has the porous layer, an intermediate layer in which part of the protective layer 3 is impregnated into the outermost surface of the porous layer is obtained, and hence the porous layer improved in film strength is obtained in the boundary part 2A. Thus, even when the optical element 10 is exposed to an abrupt temperature change, a crack in the boundary part 2A can be suppressed, and hence the peeling of the antireflection film 4 can be suppressed. An example in which the antireflection film 4 consists essentially of the porous layer is illustrated in each of FIG. 1. That is, the porous layer is the antireflection film 4.

### <Kind of Protective Layer>

The protective layer 3 is preferably formed by a wet method so that the layer may be impregnated into the porous layer. For example, the layer may be preferably formed by applying a paint containing a liquid curable material to the surface of the antireflection film 4, and then curing the paint. Examples of such material species include an epoxy resin, an acrylic resin, a urethane resin, and a silicone resin serving as liquid uncured resin materials. When such uncured resin material is diluted with an organic solvent or the like, the diluted product is applied to the outer edge portion of the porous layer by a known method, and then the applied product is dried, followed by room-temperature curing, heat curing, or UV curing, an intermediate layer in which part of the protective layer is impregnated into the outermost surface of the porous layer is obtained, and hence the occurrence of a crack particularly in the boundary part can be suppressed.

### <Physical Properties and Region of Protective Layer>

The mechanical physical properties, application thickness, and application region of the protective layer 3 are described. A region where the substrate 1, the resin layer 2, and the protective layer 3 are all present when the optical element 10 is viewed from above is referred to as “laminated region R1.” The laminated region R1 can be said to be a region where the protective layer 3 covers the resin layer 2. The width of the laminated region R1 is the same as the width of the protective layer 3 from the boundary part 2A toward a center O.

When the protective layer 3 is excessively soft, concern is raised in that its light resistance cannot be maintained, and when the layer is excessively hard, the intermediate layer may become brittle. Accordingly, the elastic modulus of the protective layer 3 is preferably 200 MPa or more and 4,000 MPa or less. When the thickness of the protective layer 3 is small, the amount of the protective layer to be impregnated into the porous layer may become smaller to reduce an improving effect on the strength of the antireflection film 4. When the protective layer 3 is thick, concern is raised about liquid dripping at the time of the application of the paint during the manufacture of the layer. Accordingly, the thickness of the protective layer 3 is preferably 1 μm or more and 100 μm or less. The protective layer 3 is preferably formed on the antireflection film 4 at least on the boundary part 2A. The laminated region R1 preferably has a width corresponding to 1% or more of the radius of the resin layer 2. That is, the protective layer 3 is preferably formed on the antireflection film 4 on the resin layer 2 by a distance corresponding to 1% or more of the radius of the resin layer 2 from the boundary part 2A serving as a starting point. The protective layer 3 can be expected to relax a stress caused by thermal shock. Accordingly, such arrangement of the laminated region R1 as described above is preferred because crack suppression is improved. In addition, the ratio of the width of the laminated region R1 to the radius of the resin layer 2 is preferably 15% or less. Such arrangement of the laminated region as described above can avoid an unnecessary increase in outer diameter of the lens. When the optical element is used as a lens for forming optical equipment (photographing optical system) for a camera or a video camera, to achieve the above-mentioned object, the width of the laminated region R1 is more preferably 0.05 mm or more and 3 mm or less.

### <Configuration of Light-Shielding Film>

For the purpose of improving the strength of the film itself of the protective layer 3 or of suppressing a ghost due to leaked light when the optical element 10 is used as an optical lens, the protective layer 3 is more preferably turned into a film having a light-shielding function by adding silica particles, coal tar, or the like.

The film having a light-shielding function serving as the protective layer 3 of the optical element 10 according to this embodiment is described in detail.

To form the light-shielding film as the protective layer 3, the protective layer 3 may contain a light-shielding film-forming composition. A compound having an epoxy group, inorganic fine particles, a coloring agent, an amine-based curing agent, and the like may each be used in the light-shielding film-forming composition. However, the light-shielding film-forming composition is not limited thereto, and a material that absorbs visible light having a wavelength of from 400 nm to 700 nm may be used. As a coloring agent serving as such material, for example, a pigment, such as carbon black, titanium black, iron oxide, or an copper-iron-manganese composite oxide, is used. In addition, when a dye is used as the coloring agent, one kind of dye may be used alone, or a plurality of dyes of, for example, black color, red color, yellow color, and blue color may be used as a mixture thereof.

In addition, an epoxy resin and a resin to which an amine-based cured product is cross-linked may each be used in the light-shielding film-forming composition. As the kind of the epoxy resin, for example, a bisphenol A-type epoxy resin, a bisphenol F-type epoxy resin, a polyfunctional epoxy resin, a flexible epoxy resin, a brominated epoxy resin, a glycidyl ester-type epoxy resin, a polymer-type epoxy resin, and a biphenyl-type epoxy resin may each be used. The epoxy resins may be used alone or as a mixture thereof. When the epoxy resin is used in the light-shielding film-forming composition, the light-shielding film-forming composition may further contain an amine-based curing agent in order to cure a compound having an epoxy group. The amine-based curing agent is not particularly limited as long as desired characteristics are satisfied, and a known amine-based curing agent may be used. Specifically, as the amine-based curing agent, there may be used, for example, linear aliphatic-based, polyamide-based, alicyclic, and aromatic curing agents, any other dicyandiamide, and adipic acid dihydrazide. Those amine-based curing agents may be used alone or as a mixture thereof.

As the inorganic fine particles, there may be used silica fine particles, and fine particles of, for example, titanium oxide, zirconium oxide, aluminum oxide, yttrium oxide, cadmium oxide, diamond, strontium titanate, and germanium.

### <Antireflection Film>

The antireflection film 4 of the optical element 10 according to this embodiment is described in detail.

The antireflection film 4 is arranged at a position in contact with air in the optical effective diameter range of the optical element 10. Accordingly, a difference in refractive index between the air and the antireflection film 4 is preferably as small as possible. A reduction in difference in refractive index between the air and the antireflection film 4 increases the degree of freedom in optical design, and hence can reduce reflection on a surface in the optical effective diameter of the optical element 10 irrespective of a material for the substrate 1.

Although the refractive index n3 of the antireflection film 4 is preferably more than 1.00 and 1.23 or less, a realistic preferred range of the refractive index is 1.10 or more and 1.23 or less in consideration of the fact that it is technically difficult to form a film having a refractive index of less than 1.10. The refractive index is more preferably 1.10 or more and 1.21 or less, still more preferably 1.15 or more and 1.20 or less. When the refractive index n3 of the antireflection film 4 is 1.10 or more and 1.21 or less, the optical element 10 suitable for use as an optical element can be achieved. When the refractive index n3 of the antireflection film 4 is 1.15 or more and 1.20 or less, a light interference layer having high antireflection characteristics and high mechanical strength can be achieved, and hence the applications of the optical element 10 expand. A refractive index at a wavelength of 550 nm is used as a refractive index in the present disclosure.

The film thickness of the antireflection film 4 is designed based on the refractive index (porosity) of the antireflection film 4 and the wavelength of light to be prevented from being reflected. However, in consideration of the refractive index n3, the film thickness is preferably 50 nm or more and 300 nm or less because a high antireflection effect is obtained. The film thickness of the antireflection film 4 is more preferably 70 nm or more and 200 nm or less, still more preferably 90 nm or more and 150 nm or less.

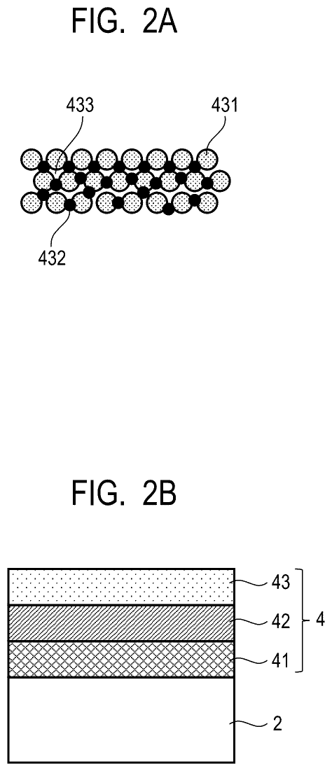

A partial enlarged view of the antireflection film 4 is illustrated in FIG. 2A. The antireflection film 4 is a porous layer containing a plurality of inorganic compound particles 431, in which the particles are bonded to each other by a binder 432, and which has voids 433 between the particles. The refractive index n3 of the antireflection film 4 may be adjusted by materials for the particles 431 and the binder 432, and the amount (porosity) of the voids 433. The porosity may be adjusted by the sizes and shapes of the particles, and the amount of the binder 432.

Inorganic compound particles each having a refractive index of less than 1.5 in at least part of a visible light region are used as the particles 431. Specifically, the inorganic compound particles are preferably particles of one kind selected from the group consisting of: silicon oxide (silica); magnesium fluoride; lithium fluoride; calcium fluoride; and barium fluoride. Of those, silica particles are particularly preferred in consideration of ease of availability. The composition of each of the particles 431 may be specified by analyzing a section of the antireflection film through use of energy dispersive X-ray analysis (EDX).

Although the particles 431 may be solid particles, cocoon-shaped particles, rice bale-shaped particles, chain-like particles, or hollow particles having pores therein, hollow particles or chain-like particles that can include many voids in the antireflection film are preferred. The particles are specifically, for example, hollow silica particles or chain-like silica particles in consideration of ease of availability. Hollow particles that easily provide a film having a low refractive index are particularly preferred because the refractive index of the antireflection film 4 is preferably as low as possible. The chain-like particles refer to secondary particles in each of which a plurality of primary particles such as solid particles are bonded to each other, and are connected in a linear or bent manner.

When the particles 431 are hollow particles, the average particle diameter of the hollow particles is preferably 15 nm or more and 300 nm or less, more preferably 30 nm or more and 200 nm or less, still more preferably 30 nm or more and 150 nm or less. When the average particle diameter is 15 nm or more and 300 nm or less, the particles can be stably manufactured, and hence the occurrence of scattering due to the occurrence of a large void between the particles can be suppressed.

The average particle diameter of the hollow particles is the average value of Feret diameters measured for a plurality of particles. The Feret diameters may each be measured from an image (sectional TEM image) obtained by taking a photograph of a section of the antireflection film 4 with a transmission electron microscope. The average value of Feret diameters measured as follows is desirably adopted as the average particle diameter: the Feret diameters of at least 50 particles are measured with commercially available image processing software such as ImageJ (manufactured by NIH) while the contrast of a TEM image is adjusted as required.

The shell thickness of each of the hollow particles is preferably 10% or more and 50% or less, more preferably 20% or more and 35% or less of the average particle diameter. When the shell thickness falls within the ranges, there is no risk in that the strength of each of the particles themselves is insufficient, and hence the particle is broken during film formation. In addition, there is no risk in that the ratio of voids in one particle becomes smaller to reduce a reducing effect on the refractive index of the antireflection film. The shell thickness of each of the hollow particles may also be measured from a sectional TEM image. The average value of shell thicknesses measured for a plurality of particles may be used.

When the particles 431 are chain-like particles, the primary particles for forming the chain-like particles may be perfectly spherical particles, cocoon-shaped particles, or rice bale-shaped particles. However, particles in each of which a long diameter is 1 times or more and 3 times or less as large as a short diameter are particularly preferred. The thickness of each of the chain-like particles corresponds to the average particle diameter of the primary particles, and the average particle diameter may be determined as the average value of Feret diameters measured for at least 50 primary particles captured in a sectional TEM image.

The average particle diameter of the primary particles for forming the chain-like particles is preferably 8 nm or more and 20 nm or less. When the average particle diameter is 8 nm or more and 20 nm or less, there is no risk in that the surface area of the voids of the antireflection film 4 excessively increases, and hence moisture or a chemical substance in its surrounding atmosphere is taken in the voids to change the optical characteristics of the antireflection film 4. In addition, no concern is raised about the following: the average particle diameter becomes excessively large to destabilize the dispersion of the chain-like particles in a solvent in a coating liquid for forming the antireflection film 4, and hence the applicability of the coating liquid deteriorates to preclude the obtainment of a layer having uniform physical properties.

The average particle diameter of the chain-like particles is preferably 3 times or more and 10 times or less, more preferably 4 times or more and 8 times or less as large as the average particle diameter of the primary particles. When the average particle diameter of the chain-like particles is 3 times or more and 10 times or less as large as the average particle diameter of the primary particles, a porosity enough to sufficiently reduce the refractive index of the porous layer is obtained, and hence there is no risk in that the viscosity of the coating liquid becomes excessively high. Further, there is no risk in that a void formed between the particles becomes larger to cause light scattering, which impairs the light transmittance of the layer, or to cause the deterioration of the applicability or leveling property of the coating liquid. The average particle diameter of the chain-like particles corresponds to the average of the Feret diameters of the secondary particles, and may be determined as the average value of Feret diameters measured for at least 50 chain-like particles from a sectional TEM image.

When the particles 431 are solid primary particles, their average particle diameter is preferably 5 nm or more and 300 nm or less, more preferably 5 nm or more and 150 nm or less, still more preferably 5 nm or more and 100 nm or less. When the average particle diameter is 5 nm or more and 300 nm or less, an increase in refractive index of the antireflection film 4 and an increase in scattering can be suppressed. The average particle diameter of the solid particles may be determined from a sectional TEM image of the layer as in particles of other shapes.

An inorganic compound of the same quality as that of the particles 431 is preferably used in the binder 432 that bonds the particles to each other. The use of the inorganic compound of the same quality as that of the particles 431 improves an affinity between the materials for the particles and the binder, and hence even when the amount of the binder is small, a strong binding force is obtained. As a result, there can be achieved a refractive index lower than that in the case where a resin binder having a low affinity for the particles 431 is used.

When the particles 431 are silica particles, a silicon oxide compound is preferred for the binder 432. The silicon oxide compound is preferably, for example, a cured product of a silicon oxide oligomer obtained by hydrolyzing and condensing a silicic acid ester.

The content of the binder 432 in the antireflection film 4 is preferably 0.2 part by mass or more and 20 parts by mass or less, more preferably 1 part by mass or more and 20 parts by mass or less when the entire amount of inorganic components (solid components) in the antireflection film 4 is defined as 100 parts by mass. When the content of the binder 432 falls within the above-mentioned ranges, the following can be suppressed: the formation of a film having low scratch resistance due to a small ratio of the binder to the particles; and an increase in refractive index of the layer caused by a reduction in porosity thereof due to a large binder content. Further, at the time of the formation of the antireflection film 4, the worsening of the visible light scattering of the film to be obtained due to the disturbance of the arrangement of the particles 431 by a component that becomes the binder in the coating liquid can be suppressed.

The binder of the protective layer 3 permeates into the voids 433 of the antireflection film 4 in the outer edge portion of the resin layer 2. Thus, the strength of the antireflection film 4 is improved after the curing of the protective layer 3.

### <Antireflection Film Formed of Plurality of Layers>

For the purpose of further suppressing the reflection of light entering and emitted from the optical element 10, the antireflection film 4 may include a plurality of layers as illustrated in FIG. 2B. In the example of FIG. 2B, the antireflection film 4 includes a first layer 41, a second layer 42 arranged on the first layer, and a third layer 43 arranged on the second layer in the stated order from the substrate side or the resin layer side. Light interference by those three layers can suppress the reflection of the light entering the optical element 10. Such light interference can be effectively achieved by the following setting: the third layer 43 is the porous layer containing the inorganic compound particles; and one of the first layer 41 or the second layer 42 is an organic layer, and the other thereof is an inorganic compound layer.

The optical element 10 including the plurality of layers is suitable for an optical lens that is required to have particularly high antireflection performance, and hence the element may be used in various kinds of optical equipment. The element is suitable for an optical lens incorporated into a photographing optical system included in an image pickup apparatus out of such equipment. When the optical element 10 according to the present disclosure is used in a photographing optical system, until light from the outside forms an image on an image pickup device via the photographing optical system, the reflection of the light on the surface of the optical element 10 is suppressed, and hence the light transmittance of the element is improved, and a flare and a ghost are significantly reduced. As a result, a high-quality image can be obtained.

In the antireflection film 4 formed of the plurality of layers, when the porous layer having the lowest refractive index is arranged as the third layer 43 located closest to the air, the refractive indices of the respective layers for obtaining an antireflection effect desirably satisfy one of the following relational formulae. Herein, the refractive index of the first layer is represented by n1, the refractive index of the second layer is represented by n2, and the refractive index of the third layer is represented by n3.

$$n 3 < n 1 < n 2. \qquad Relational formula 1$$

$$n 3 < n 2 < n 1. \qquad Relational formula 2$$

### <Buffer Layer>

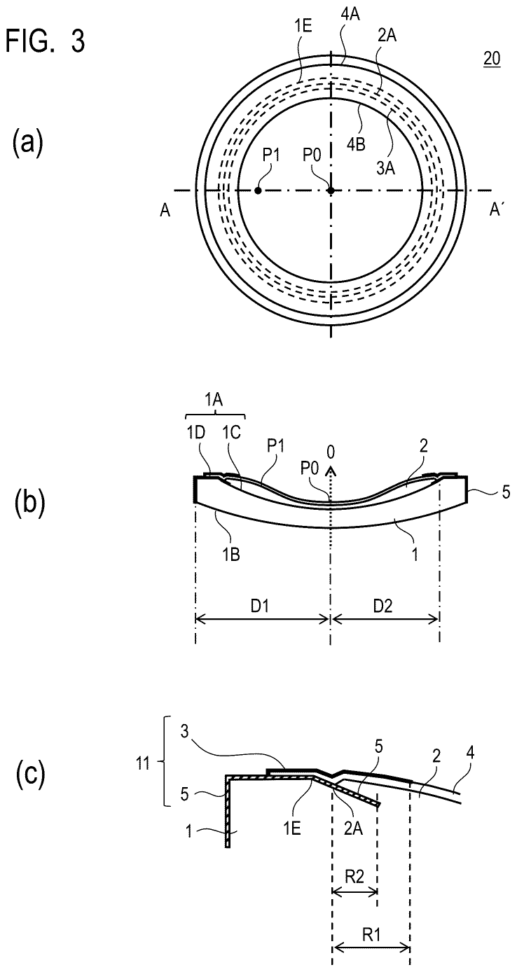

An optical element including a buffer layer is described as a modified example of the optical element according to this embodiment. FIG. 3 is a schematic view for illustrating the configuration of an optical element 20 that is a modified example of this embodiment. (a) of FIG. 3 is a top view of the optical element 20. (b) of FIG. 3 is a sectional view in a thickness direction taken along the line A-A′ in (a) of FIG. 3. (c) of FIG. 3 is a sectional view for illustrating part of the optical element 20 in an enlarged manner.

In the optical element 20, a buffer layer 5 is arranged between the resin layer 2 and the substrate 1 from the outer edge of the resin layer 2 to the outside. That is, the buffer layer 5 is arranged between the resin layer 2 and the substrate 1 so as to cover the boundary part 2A. With such arrangement, when such thermal shock that the optical element 20 is rapidly cooled occurs, the buffer layer 5 can relax a thermal stress resulting from a difference in linear expansion coefficient between the resin layer 2 and the substrate 1, and hence can further suppress the occurrence of a crack in the antireflection film 4 in the boundary part 2A. Thus, the optical element 20 having long-term excellent environmental durability can be obtained.

A region where the substrate 1, the buffer layer 5, and the resin layer 2 are all present when the optical element 20 is viewed from above is referred to as “laminated region R2.” The width of the laminated region R2 is the same as the width of the buffer layer 5 from the boundary part toward the center O. It is preferred that the buffer layer 5 be free from existing beyond the laminated region R2 when the optical element 20 is viewed from above.

Although the buffer layer 5 is present from the outermost edge of the optical element 20 to the side surface thereof in the example of FIG. 3, the buffer layer 5 only needs to be present between the resin layer 2 and the substrate 1 so as to cover the boundary part 2A.

The buffer layer 5 preferably includes the same material as that of the protective layer 3. The use of the same material can more effectively suppress the peeling of the antireflection film due to a thermal stress at a contact point between the protective layer 3 and the buffer layer 5.

Further, both the protective layer 3 and the buffer layer 5 are preferably light-shielding films 11 formed of the same material. When the protective layer 3 and the buffer layer 5 are the light-shielding films 11 formed of the same material, the peeling due to the thermal stress at the contact point between the protective layer 3 and the buffer layer 5 can be suppressed, and moreover, unnecessary leaked light can be shielded. However, even when the protective layer 3 is not the light-shielding film 11, a suppressing effect on the peeling of the antireflection film is obtained.

When the optical element 20 is used in a high-temperature environment, the film cracking of the protective layer 3 may occur owing to the thermal expansion of the light-shielding film serving as the buffer layer 5 and the expansion of the resin layer 2. To suppress the foregoing, the thickness of the buffer layer 5 is preferably smaller than the thickness of the protective layer 3.

A relationship between the sizes of the laminated region R2, which is a laminated region including the buffer layer 5, and the laminated region R1, which is a laminated region including the protective layer 3, is preferably R1>R2. The energy of light to be applied at the time of the UV curing of the resin layer on the laminated region R2 to be described later is low. As a result of the foregoing, the thermal expansion of the end portion of the resin layer 2 may become larger to cause the peeling of the antireflection film 4. Accordingly, it is preferred that the resin layer 2 in the laminated region R2 be completely covered with the protective layer 3. Thus, the peeling can be suppressed.

A case in which each of the protective layer 3 and the buffer layer 5 is the light-shielding film 11 is illustrated in each of FIG. 3. As illustrated in each of FIG. 3, the light-shielding film 11 is continuously arranged from the side surface part of the substrate to the flat surface 1D of the substrate, and the laminated region R2 including the boundary part 2A is continuously formed from the flat surface 1D to the optical surface 1C across the ridge line 1E to serve as the buffer layer 5. Thus, the protective layer 3 can be laminated in the laminated region R1 of the antireflection film 4 including the boundary part 2A. However, the configurations of the resin layer 2 and the light-shielding film 11 in the present disclosure are not limited to the example illustrated in each of FIG. 3. The following may be performed: the buffer layer 5 is arranged only in the laminated region R2 including the boundary part 2A from the ridge line 1E, and the light-shielding film is continuously arranged as the protective layer 3 from the side surface part of the substrate to the flat surface 1D of the substrate, and is continuously formed from the flat surface 1D to the laminated region R1 on the antireflection film 4.

### <Resin Layer>

In the optical element 10 illustrated in each of FIG. 1, the thickness of the resin layer 2 having an aspherical shape becomes maximum at a point P1 located between a center P0, which is the center of the optical surface 1C that is a spherical surface, and an end portion, and the thickness at the point P1 is larger than the thickness at the center P0. Herein, the thickness of the resin layer 2 refers to a thickness in the optical axis direction O with respect to the optical surface 1C that is a spherical surface of the substrate 1. In the present disclosure, the thickness of the resin layer 2 at a point Px, which is a certain point in a radial direction of the optical surface 1C, is regarded as an average value of thicknesses obtained by measurement at a total of three points, that is, the point Px, and a point Px-1 and a point Px+1, which are two points adjacent to the point Px that are each distant from the point Px by 0.5 mm in the radial direction of the optical surface 1C. In this case, the point Px-1 is a point positioned closer to the center P0 than the point Px is, and the point Px+1 is a point positioned closer to the outer edge of the optical surface 1C than the point Px is.

The resin layer 2 is molded so that its thickness may be the maximum thickness, which is larger than the thickness at the center P0, at the point P1 located between the center P0 and the end portion. Thus, the optical element 10 serving as a replica lens is formed as an aspherical lens having an aspherical shape.

The optical element 10 preferably satisfies at least one of the following two conditions for the resin layer 2. One condition is that the maximum thickness of the resin layer 2 in the optical axis direction O is 5 times or more as large as the thickness (center thickness) of the resin layer 2 in the optical axis direction O at the center position P0 of the optical surface 1C. The optical element 10 in which the maximum thickness is 5 times or more as large as the center thickness has such optical characteristics as to be capable of being suitably used as the front lens element of a wide-angle zoom lens because its amount of asphericity is large.

The other condition is that the minimum thickness of the resin layer 2 in the optical axis direction O is ⅕ or less of the thickness (center thickness) of the resin layer 2 in the optical axis direction O at the center position P0 of the optical surface 1C. The optical element 10 in which the minimum thickness is ⅕ or less of the center thickness also becomes a lens having a large amount of asphericity, and hence the correction of distortion and chromatic aberration is more effective. Accordingly, the use of the optical element 10 satisfying the condition provides excellent image quality in, for example, a wide-angle lens or a telephoto lens that is required to have a particularly wide field of view.

Meanwhile, in a replica lens having a large amount of asphericity, a crack is liable to occur in the antireflection film 4 owing to a stress caused by thermal shock under the influence of an increase in residual stress at the time of the molding of the lens. The foregoing results from the fact that when the thickness of the resin layer 2 is excessively large, the thermal stress becomes larger in accordance with the thickness, and as a result, a probability that a crack occurs in the antireflection film 4 increases. The concentration of the stress caused by thermal shock is liable to occur particularly in the antireflection film formed on the boundary part 2A, and hence it is preferred to interpose the light-shielding film 11 as the buffer layer 5 on the boundary part 2A. That is, the light-shielding film 11 is preferably arranged so as to spread from the flat surface 1D, cross the boundary part, and reach part of the optical surface 1C as illustrated in (b) of FIG. 3. In this case, a distal end 3A of the light-shielding film 11 arranged on the first surface 1A is brought into a state of being arranged on the optical surface 1C.

A substrate formed of transparent glass may be used as the substrate 1. The term “transparent” as used herein means a transmittance of 10% or more for light in the wavelength range of 400 nm or more and 780 nm or less. Specifically, the substrate 1 may be, for example, a substrate formed of general optical glass typified by silicate glass, borosilicate glass, or phosphate glass, quartz glass, or glass ceramics.

Although a case in which the optical surface 1C has a concave spherical shape and the second surface 1B has a convex spherical shape is illustrated in each of FIG. 1, the shape of the substrate 1 is not particularly limited. The shape of the optical surface 1C included in the first surface 1A, which is the surface of the glass substrate 1 in contact with the resin layer 2, may be appropriately selected from, for example, a concave spherical shape, a convex spherical shape, an axially symmetric aspherical shape, and a planar shape in accordance with desired characteristics.

As illustrated in (a) of FIG. 1, the substrate 1 preferably has a circular planar shape when viewed in plan view in a direction along the optical axis of the optical element 10 passing through the center P0 of the optical surface 1C, which is a lens center. When the substrate 1 has a circular planar shape, the precision with which the optical element 10 is assembled in the case of using the optical element 10 as a lens in an optical system as described later can be improved.

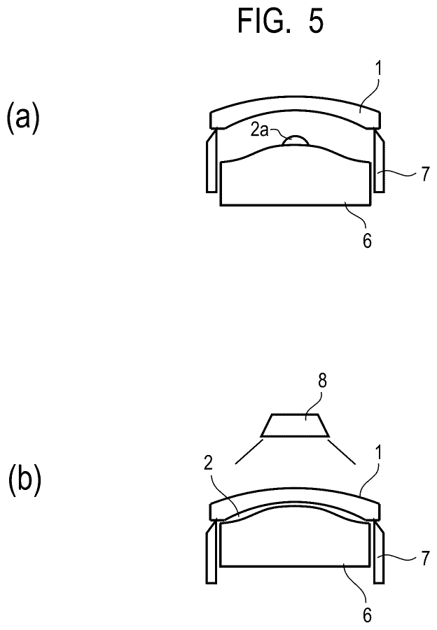

In this embodiment, the surface of the resin layer 2 has an aspherical shape. A resin composition 2a (see (a) of FIG. 5) for forming the resin layer 2 is preferably a polymer composition that is an energy-curable composition suitable for molding with use of a mold. The energy-curable composition is a composition containing a component that becomes a resin from an uncured state through polymerization and curing caused by imparting one or both of optical energy and thermal energy. Of the energy-curable compositions, a UV-curable resin composition is more preferred as the resin composition 2a. For example, a monomer having a (meth)acrylate group and an epoxy resin may each be used as a UV-curable material in the UV-curable resin composition. The term “(meth)acrylate” as used herein means an acrylate or a methacrylate. That is, for example, the term “(meth)acrylate group” means an acrylate group or a methacrylate group.

The resin layer 2 that is a cured product of the resin composition 2a is formed of an organic material, and hence there is a difference in linear expansion coefficient between the substrate 1 and the resin layer 2 when the resin layer 2 is combined with the substrate 1. Accordingly, when a temperature change occurs in the optical element 10 configured as described above, a thermal stress is generated mainly in the resin layer 2 on the ridge line 1E. However, according to this embodiment, as described above, such thermal stress is dispersed, and hence the cracking of the resin layer 2 due to the thermal stress can be suppressed or prevented.

The resin composition 2a for forming the resin layer 2 contains a curable material, and a polymerizable monomer may be used as the curable material. Examples of the polymerizable monomer may include: (meth)acrylate monomers, such as methyl methacrylate, ethylene methacrylate, methyl acrylate, ethyl acrylate, and butyl acrylate, (meth)acrylate monomers each having an alicyclic skeleton, such as a tricyclodecane skeleton, an isobornyl skeleton, a dicyclopentenyl skeleton, or an adamantane skeleton, in a side chain thereof or the main skeleton thereof, and a (meth)acrylate having a fluorene skeleton, a (meth)acrylate having a phenoxybenzyl skeleton, and a (meth)acrylate having a bisphenol skeleton each intended for increasing the refractive index of the composition; and ethylenically unsaturated monomers, such as acrylic acid, styrene, butadiene, and divinylbenzene.

In addition, for the purpose of facilitating the handling of the resin composition 2a, adjustment such as an increase in viscosity of the resin composition 2a may be performed by using, as the curable material, a polymerizable monomer that has been increased in molecular weight in advance.

The resin composition 2a used in each of Examples 1 to 18, which is a mixture of a (meth)acrylate monomer having an alicyclic skeleton and a polymer thereof, is characterized by being transparent and having a low water absorption expansion rate under high temperature and high humidity.

In addition, the resin composition 2a used in Example 19 is characterized by having a high refractive index, flexibility, and a low curing shrinkage rate by including the following three components: (A) a bifunctional (meth)acrylate compound having a fluorene skeleton, the compound being represented by the following general formula (1); (B) a monofunctional (meth)acrylate compound having a phenoxybenzyl skeleton, the compound being represented by the following general formula (2); and (C) a bifunctional (meth)acrylate having a bisphenol skeleton, the compound being represented by the following general formula (3). The (meth)acrylate having a fluorene skeleton serving as the component (A) is characterized by having a high refractive index and a small curing shrinkage rate, and its ratio in the resin composition 2a falls within the range of preferably 10 parts by weight or more and 40 parts by weight or less, more preferably 15 parts by weight or more and 30 parts by weight or less. The (meth)acrylate having a phenoxybenzyl skeleton serving as the component (B) is characterized by having a maintaining effect on the refractive index of the composition and a lowering effect on the viscosity thereof, and its ratio in the resin composition 2a falls within the range of preferably 5 parts by weight or more and 30 parts by weight or less, more preferably 10 parts by weight or more and 25 parts by weight or less. The (meth)acrylate having a bisphenol skeleton serving as the component (C) is characterized by having flexibility and improving the environmental durability of the optical element, and [m+n] representing the length of its molecular chain is preferably 2 or more and 10 or less, and is more preferably 3 or more and 6 or less in terms of the flexibility and shape stability of the composition. The ratio of the component (C) in the resin composition 2a falls within the range of preferably 35 parts by weight or more and 70 parts by weight or less, more preferably 45 parts by weight or more and 60 parts by weight or less.

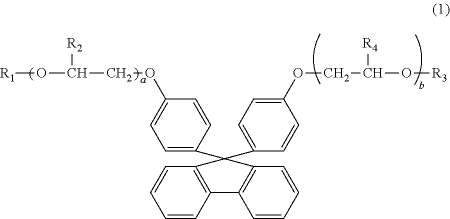

In the formula (1), R₁ and R₃ each independently represent any one of polymerizable functional groups represented by the formulae (a) to (e), R₂ and R₄ each independently represent a hydrogen atom or a methyl group, and “a” and “b” each independently represent an integer of from 1 to 4.

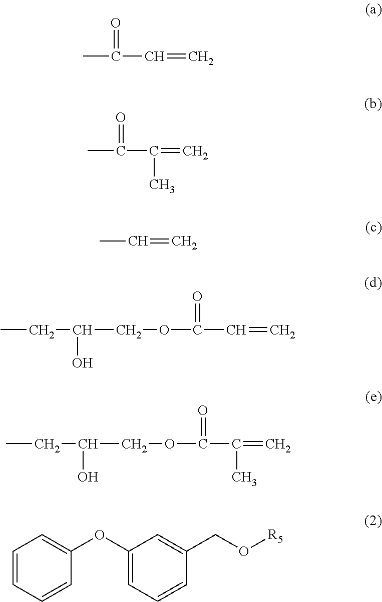

In the formula (2), R₅ represents any one of the polymerizable functional groups represented by the formulae (a) to (e).

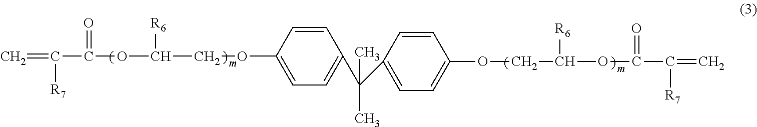

In the formula (3), R₆ and R₇ each independently represent a hydrogen atom or a methyl group, and “m” and “n” represent such integers that m+n is from 2 to 10.

In addition, to adjust optical properties and mechanical properties, the resin composition 2a may further contain any other organic substance or inorganic substance in addition to the curable material.

In addition, the resin composition 2a may contain a polymerization initiator. The polymerization initiator may be a photopolymerization initiator or a thermal polymerization initiator, and which one of the two is to be used may be determined by what manufacturing process is selected. However, when replica molding for forming the aspherical shape of the resin layer 2 is performed, the polymerization initiator is preferably a photopolymerization initiator in view of its high curing speed.

Examples of a commercially available photopolymerization initiator include 2-benzyl-2-dimethylamino-1-(4-morpholinophenyl)-1-butanone, 1-hydroxycyclohexyl phenyl ketone, bis(2,4,6-trimethylbenzoyl)-phenyl phosphinoxide, 4-phenylbenzophenone, 4-phenoxybenzophenone, 4,4′-diphenylbenzophenone, and 4,4′-diphenoxybenzophenone.

The content of the photopolymerization initiator in the resin composition 2a preferably falls within the range of 0.01 mass % or more and 10 mass % or less. When the content of the photopolymerization initiator is 0.01 mass % or more, high reactivity can be obtained, and when the content is 10 mass % or less, a drop in light transmittance of the resin layer 2 that is a cured product can be suppressed. An unreacted portion of the polymerization initiator remains in the resin layer 2 that is a cured product.

In addition, the resin composition 2a may contain, for example, a polymerization inhibitor, an antioxidant, a light stabilizer (HALS), a UV absorber, a silane coupling agent, a mold release agent, a pigment, and a dye, as required.

The resin layer 2 preferably has high transparency. Specifically, the resin layer 2 preferably has an internal transmittance of 70% or more when converted to a thickness of 500 μm, with respect to light having a wavelength of 400 nm.

Next, a method of manufacturing the optical element 10 according to this embodiment is described. In this example of the manufacturing method, the protective layer 3 is a light-shielding film. In addition, when the buffer layer 5 is further arranged, the buffer layer 5 is also a light-shielding film formed of the same material as that of the protective layer 3.

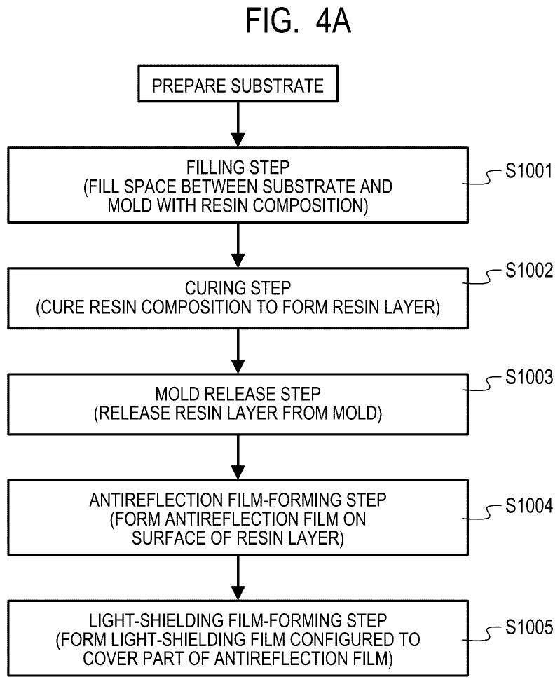

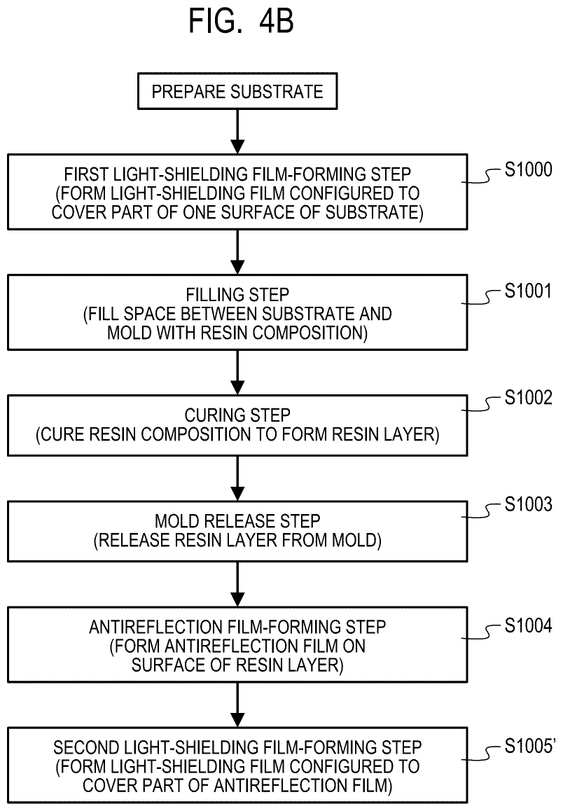

The method of manufacturing the optical element 10 includes the following steps as illustrated in FIG. 4A: a filling step (Step S1001) of filling a space between a substrate and a mold with a resin composition; a curing step (Step S1002) of curing the resin composition to form the resin layer; a mold release step (Step S1003) of releasing the resin layer from the mold; an antireflection film-forming step (Step S1004) of forming an antireflection film on the surface of the resin layer; and a light-shielding film-forming step (Step S1005) of forming a light-shielding film configured to cover part of the antireflection film.

FIG. 5 is a sectional view for illustrating the arrangement of each component or the like in a step of forming the resin layer 2 of the optical element 10 illustrated in each of FIG. 1 on the first surface 1A of the substrate 1. In each of FIG. 5, the arrangement of each component or the like for an apparatus for forming the resin layer is illustrated in a section along the direction in which the substrate 1 and the resin layer 2 are laminated.

### <Preparation of Substrate>

First, the substrate 1 and the resin composition 2a for forming the resin layer 2 are prepared.

In this case, the first surface 1A of the substrate 1 is preferably subjected to pretreatment in order to improve adhesiveness between the substrate 1 and the resin layer 2 that is a cured product of the resin composition 2a.

When the substrate 1 is formed of glass, for example, silane coupling treatment, corona discharge treatment, UV ozone treatment, or plasma treatment may be selected as the pretreatment.

Coupling treatment using a silane coupling agent is preferably performed as the pretreatment in view of its capability of further enhancing adhesiveness by direct chemical bonding of a surface on which the resin layer 2 is formed such as the first surface 1A and the resin layer 2. That is, an application step of applying the coupling agent to at least part of the first surface 1A is preferably further provided prior to the subsequent filling step.

Specific examples of the silane coupling agent include 3-methacryloxypropylmethyldimethoxysilane, 3-methacryloxypropyltrimethoxysilane, 8-methacryloxyoctyltrimethoxysilane, 3-acryloxypropyltrimethoxysilane, 3-methacryloxypropylmethyldiethoxysilane, and 3-methacryloxypropyltriethoxysilane.

### <Filling Step>

Subsequently, in the filling step, a space between the substrate 1 and a mold 6 is filled with the resin composition 2a. Specifically, first, the resin composition 2a is dropped onto the surface of the mold 6 as illustrated in (a) of FIG. 5. Alternatively, the resin composition 2a may be dropped onto both the mold 6 and the substrate 1, or may be dropped only onto the substrate 1.

As described above, the resin composition 2a is, for example, a composition of a UV-curable resin containing a photopolymerization initiator. In addition, the substrate 1 is placed on an ejector 7 and arranged at a position facing the mold 6. The mold 6 is, for example, a metal mold that has, on its surface, an inverted shape of a desired aspherical shape, and that may be fabricated by plating a metal base material, such as a stainless-steel material or a steel material, with NiP or oxygen-free copper, and cutting the plated base material with a precision machining machine. In addition, a mold release agent may be applied to the surface of the mold 6 in order to control the mold releasability of the resin layer 2. The kind of the mold release agent is not particularly limited, and, for example, a fluorine coating agent may be used as the mold release agent.

Subsequently, as illustrated in (b) of FIG. 5, the resin composition 2a is arranged on the substrate 1 by lowering the ejector 7 to bring the mold 6 close to the substrate 1. The space between the mold 6 and the substrate 1 is filled with the resin composition 2a that is uncured by further lowering the ejector 7, and the resin composition 2a is molded into a desired shape.

### <Curing Step>

Subsequently, in the curing step, the resin composition 2a is cured to form the resin layer 2. An example of curing the resin composition 2a by irradiating the resin composition 2a with UV light is described here.

As illustrated in (b) of FIG. 5, a UV light source 8 is used to perform light irradiation in which UV light is applied to the resin composition 2a between the substrate 1 and the mold 6 from the second surface 1B side of the substrate 1. The resin composition 2a is thus polymerized and cured. Thus, the resin layer 2 that is a polymerized and cured product of the resin composition 2a is obtained. When the resin composition 2a contains a thermal polymerization initiator as a curing initiator, the curing step may include a thermal treatment step.

### <Mold Release Step>

Then, in the mold release step, the resin layer 2 that has been polymerized and cured is released from the mold 6. Thus, the optical element 10 including the resin layer 2 that is formed on the glass substrate 1 and that has an aspherical shape is obtained.

After the formation of the resin layer 2, additional application of UV light or thermal treatment may be performed in the atmospheric air or in an oxygen-free atmosphere.

### <Antireflection Film-Forming Step (Preparation of Coating Liquid)>

Subsequently, in the step of forming the antireflection film, a coating liquid is prepared. The coating liquid contains: components (solid components) that become the inorganic compound particles 431 and the binder 432 for forming the antireflection film 4; and a solvent. An organic solvent or water may be used as the solvent, and the coating liquid is preferably applied by a spin coating method or spray coating.

The material, shapes, and sizes of the particles in the coating liquid are as described above. The average particle diameter of the particles in the coating liquid may be calculated as follows: the particles are extracted from the coating liquid and washed, followed by drying; a TEM image of the particles is obtained; and the Feret diameters of 50 or more of the particles are measured, and their average value is adopted as the average particle diameter.

The binder that bonds the particles to each other is preferably an inorganic material of the same quality as that of the particles. When silica particles are used as the particles, the binder is preferably silica, and the component that becomes the binder is preferably a silicon oxide compound. The silicon oxide compound is preferably, for example, a silicon oxide oligomer obtained by hydrolyzing and condensing a silicic acid ester.

The content of the component that becomes the binder in the coating liquid is preferably 0.2 part by mass or more and 20 parts by mass or less, more preferably 1 part by mass or more and 15 parts by mass or less, still more preferably 3.0 parts by mass or more and 15 parts by mass or less with respect to 100 parts by mass of the solid components in the coating liquid. When the content of the component that becomes the binder is 0.2 part by mass or more and 20 parts by mass or less, the following can be suppressed: a reduction in mechanical strength of the antireflection film due to weakened bonding between the particles; and an increase in refractive index thereof due to an increase in content of the component that becomes the binder. Further, for example, the worsening of the visible light scattering of the film to be obtained due to the disturbance of the arrangement of the particles by the component that becomes the binder can be suppressed.

### <Antireflection Film-Forming Step (Curing of Coating Film)>

After the coating liquid has been applied onto the resin layer 2 to form a coating film of the antireflection film, the coating film is cured by removing the solvent therefrom. The curing is preferably performed at 20° C. or more and 200° C. or less, though a preferred temperature depends on the heat-resistant temperature of the substrate 1. A curing time only needs to be such a time period that the substrate 1 is not affected and the solvent in the coating film can be removed. As an approach to curing the coating film, heating may be performed with an oven or a hot plate, or the curing may be performed over time without any active heating.

### <Light-Shielding Film-Forming Step (Step of Preparing Paint for Forming Light-Shielding Film)>

A paint for forming a light-shielding film to be used in the method of manufacturing the optical element of the present disclosure is preferably prepared by mixing and dispersing the materials of the paint for the protective layer 3 described above. As a mixing and dispersing method, a ball mill, a bead mill, an impingement disperser, a planetary centrifugal mixer, a homogenizer, a stirrer, or the like may be used. The inorganic fine particles are preferably used after being nano-dispersed. A method for the nano-dispersion is specifically, for example, a method of nano-dispersing the fine particles with a bead mill or an impingement disperser. Alternatively, the fine particles may be nano-dispersed at the time of their synthesis by a sol-gel method, or a commercially available product that has been nano-dispersed in advance may be used.

### <Light-Shielding Film-Forming Step (Application of Paint for Forming Light-Shielding Film)>

In the application of the paint for forming a light-shielding film, the above-mentioned paint is applied onto the antireflection film 4 located in the boundary part 2A of the resin layer 2. Various known methods, such as a dip method, a spin coating method, a slit coating method, an electrostatic coating method, and application with an application jig, such as a brush, a sponge, or a bar coater, may each be selected as a method of applying the paint for forming a light-shielding film in accordance with a desired coating shape.

### <Light-Shielding Film-Forming Step (Curing of Paint for Forming Light-Shielding Film)>

In the curing of the paint for forming a light-shielding film, the applied paint is cured. To cure the paint, the applied paint may be dried or baked.

When the paint is dried, the drying is performed preferably at a temperature of 20° C. or more and 100° C. or less, more preferably at a temperature of 40° C. or more and 80° C. or less, still more preferably at a temperature of 40° C. or more and 60° C. or less. A drying time is preferably 10 minutes or more and 24 hours or less, more preferably 30 minutes or more and 24 hours or less, still more preferably 1 hour or more and 24 hours or less. When the paint is baked, the baking is performed preferably at a temperature of 40° C. or more and 300° C. or less, more preferably at a temperature of 40° C. or more and 250° C. or less, still more preferably at a temperature of 40° C. or more and 200° C. or less. A baking time is preferably 10 minutes or more and 10 hours or less, more preferably 10 minutes or more and 6 hours or less.

The optical element 10 according to this embodiment can be manufactured by the above-mentioned manufacturing method.

To manufacture the optical element 20 that is a modified example of the optical element, as illustrated in FIG. 4B, an additional light-shielding film-forming step (Step S1000) is provided to form a light-shielding film configured to cover the side surface of the substrate 1 and part of one surface of the substrate 1, and the film may be used as the above-mentioned buffer layer 5. In FIG. 4B, for distinction, the above-mentioned light-shielding film-forming step is illustrated as a first light-shielding film-forming step (Step S1000), and the additional light-shielding film-forming step is illustrated as a second light-shielding film-forming step (Step S1005′).

A case in which the buffer layer 5 is arranged on the substrate 1 to provide the laminated region R₂ as described above is preferred from the viewpoint of suppressing a crack in the antireflection film 4 in the boundary part 2A.

In addition, in the case where the antireflection film 4 includes a plurality of layers, the layer may be manufactured by the same method as that in the case where the above-mentioned antireflection film 4 is formed of a single layer.

### Second Embodiment

The optical element 10 according to the first embodiment described above is applicable to various kinds of equipment and apparatus, such as optical equipment and an image pickup apparatus. In this embodiment, optical equipment and an image pickup apparatus are described as specific application examples of the optical element 10 according to the first embodiment.

### (Optical Equipment)

Specific application examples of the optical element 10 according to the first embodiment include a lens to be included in optical equipment (a photographing optical system) for a still camera or a video camera, and a lens to be included in optical equipment (a projection optical system) for a liquid crystal projector. In addition, the optical element 10 may be used as a pickup lens of a DVD recorder or the like. Those pieces of optical equipment each include a housing, and an optical system that is placed inside the housing and includes at least one lens. In addition, the optical equipment according to this embodiment is characterized in that the at least one lens is the optical element 10 according to the first embodiment.

### (Image Pickup Apparatus)

An image pickup apparatus according to this embodiment is an image pickup apparatus including: a housing; an optical system that is placed inside the housing and includes at least one lens; and an image pickup device that receives light that has passed through the optical system. The image pickup apparatus according to this embodiment is characterized in that the at least one lens is the optical element 10 according to the first embodiment.

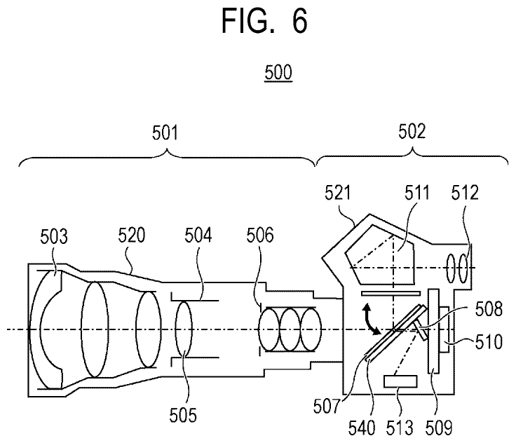

FIG. 6 is a schematic view for illustrating the configuration of a single-lens reflex digital camera 500, which is an example of an exemplary embodiment of the image pickup apparatus using the optical element 10 according to the first embodiment. In FIG. 6, a camera main body 502 and a lens barrel 501, which is optical equipment, are joined to each other, but the lens barrel 501 is a so-called replacement lens, which is detachably attachable from the camera main body 502.

Light from an object is photographed via the optical system including a plurality of lenses 503, 505, and others arranged on the optical axis of a photographing optical system inside a housing 520 of the lens barrel 501. The optical element 10 according to the first embodiment may be used for the lenses 503 and 505, for example. In this case, the lens 505 is supported by an inner barrel 504 in a manner that enables the lens 505 to move relative to the outer barrel of the lens barrel 501, for focusing and zooming.

In an observation period prior to photographing, the light from the object is reflected by a main mirror 507 inside a housing 521 of the camera main body, transmitted through a prism 511, and then viewed through a finder lens 512 by a photographer as a photographed image. The main mirror 507 is, for example, a half mirror, and light transmitted through the main mirror is reflected by a sub-mirror 508 in a direction of an auto-focus (AF) unit 513. This reflected light is used for ranging, for example. In addition, the main mirror 507 is attached to and supported by a main mirror holder 540 through adhesive bonding or the like. In photographing, the main mirror 507 and the sub-mirror 508 are moved by a driving mechanism (not shown) to outside of an optical path, and a shutter 509 is opened so that an image pickup device 510 receives the light that has entered from the lens barrel 501 and that has been transmitted through the photographing optical system, and forms a photographing light image. A stop 506 is configured so that brightness and a focal depth in photographing can be changed by changing an opening area.

Although the image pickup apparatus has been described above by using a single-lens reflex digital camera, the optical element 10 may be similarly used for a smartphone, a compact digital camera, a drone, and the like.

### EXAMPLES

The present disclosure is described in more detail below by way of Examples. First, a method of evaluating an optical element is described. The optical element was evaluated for the appearance of the optical element and lens cracking.

### (Appearance Evaluation)

Each of the optical elements obtained in Examples and Comparative Examples was loaded into a temperature cycle tester in which a temperature was able to be changed between −30° C. and 80° C. every 1 hour, and 100 cycles of a thermal shock test was performed, followed by the evaluation of the optical element for a crack in, and the peeling of, its antireflection film. At that time, the level at which absolutely no peeling occurred was ranked A, the level at which no peeling occurred but a small crack at such a level as to cause no problem with the optical performance of the optical element was visible was ranked B, and the level at which a crack and peeling were clearly visible was ranked C.

Optical elements according to Examples and Comparative Examples are described next.

### Example 1

### (Formation of First Light-Shielding Film)

The following optical glass (S-TIM8, manufactured by Ohara Inc.) having a diameter of 30 mm was prepared as a substrate: the optical glass had the flat surface 1D with a width of 2 mm, and had the ridge line 1E between the flat surface 1D and the optical surface 1C. A paint for forming a light-shielding film (GT-7II: manufactured by Canon Chemicals Inc.) was applied to the substrate 1 to form a buffer layer. The paint for forming a light-shielding film was applied up to the optical surface 1C across the ridge line 1E, and the application width of the buffer layer from the boundary part was set to 0.1 mm, that is, the width of the laminated region R2 was set to 0.1 mm, and the inner diameter of the buffer layer was set to 25.4 mm. The shape of the substrate is as follows: one surface (optical surface 1C) thereof is a concave spherical shape having a diameter of 26 mm, and the other surface (second surface 1B) thereof is a convex spherical shape having a diameter of 30 mm.

### (Formation of Resin Layer)

A resin layer was formed with the apparatus illustrated in each of FIG. 5 described above. A mold obtained as follows was used as the mold 6: a NiP layer plated on a metal base material was subjected to cutting machining with a precision machining machine to form a shape that was an inversion of the aspherical shape of the resin layer 2, which was to be molded.

The inner surface of the ejector 7 was subjected to mirror finish machining for the purpose of reflecting UV light.

Next, a silane coupling agent containing a methacrylic group as a functional group was applied to the surfaces of the substrate 1 and the buffer layer 5 for the purpose of improving adhesiveness between the substrate 1 and the resin layer 2.

Next, a space between the mold 6 and the substrate 1 was filled with the resin composition 2a. A resin composition containing 32 parts by weight of dicyclopentenyloxyethyl methacrylate, 40 parts by weight of tricyclodecanedimethanol diacrylate, 26 parts by weight of a polymer obtained by polymerizing dicyclopentenyloxyethyl methacrylate, and 2 parts by weight of a polymerization initiator (1-hydroxycyclohexyl phenyl ketone) was used as the resin composition 2a.

Then, UV light having an intensity of 10 mW/cm² at a wavelength of 365 nm was applied to entire surface for 200 seconds to cure the resin composition 2a, and the cured product of the resin composition 2a was released from the mold 6 to form the resin layer 2 on the substrate 1. An intermediate obtained by mold release was loaded into an oven and heated at 80° C. for 24 hours. The outer diameter of the resultant resin layer was 25.6 mm.

### (Formation of Antireflection Film)

Next, the following coating liquid was applied onto the resultant resin layer to form an antireflection film. The antireflection film included a plurality of layers.

### (Coating Liquid 41a for Forming First Layer)

PGM-ST (particle diameter: 10 nm, solid content concentration: 30 mass %) manufactured by Nissan Chemical Corporation was used as a propylene glycol monomethyl ether dispersion of spherical solid silica (silicon oxide) particles. 1-Propoxy-2-propanol was added to 100 g of the propylene glycol monomethyl ether dispersion of the solid silica particles so that the solid content concentration was 3.8 mass %.

In a separate container, 13.82 g of ethanol and an aqueous nitric acid solution (concentration: 3%) were added to 12.48 g of ethyl silicate, and the mixture was stirred at room temperature for 10 hours to prepare a silica sol 1 (solid content concentration: 11.5 mass %). Gas chromatography recognized that the ethyl silicate component serving as a raw material did not remain.

The silica sol 1 was added to the dispersion of the solid silica particles so that a ratio between the silica particles and the silica sol component was 25:3. Further, the materials were stirred and mixed at room temperature for 2 hours to provide a coating liquid 41a containing the solid silica particles.

### (Coating Liquid 42a for Forming Second Layer)

Hexane was gradually added to 200 g of 4,4′-methylenebis(aminocyclohexane) (hereinafter referred to as “DADCM”, manufactured by Tokyo Chemical Industry Co., Ltd.) while being refluxed. Thus, complete dissolution was achieved. After heating had been stopped and the mixture had been left at room temperature for several days, a precipitate was separated by filtration and dried under reduced pressure. 58 Grams of the alicyclic diamine DADCM in a white solid form was obtained.

Three kinds of diamines, that is, the alicyclic diamine DADCM, an aromatic diamine 4,4′-bis(4-aminophenoxy)biphenyl (product name: BODA, manufactured by Wakayama Seika Kogyo Co., Ltd.), and a siloxane-containing diamine 1,3-bis(3-aminopropyl)tetramethyldisiloxane (product name: PAM-E: manufactured by Shin-Etsu Chemical Co., Ltd.) were dissolved in N,N-dimethylacetamide (hereinafter referred to as “DMAc”) so that their total amount was 12 mmol.

About 12 mmol of an acid dianhydride was added to the diamine solution while the solution was cooled with water. 4-(2,5-Dioxotetrahydrofuran-3-yl)-1,2,3,4-tetrahydronaphthalene-1,2-dicarboxylic acid anhydride (product name: TDA-100: manufactured by New Japan Chemical Co., Ltd.) was used as the acid dianhydride. The amount of DMAc was adjusted so that the total mass of the diamines and the acid dianhydride was 20 mass %.

The solution was stirred at room temperature for 15 hours to perform a polymerization reaction. Further, the resultant was diluted with DMAc so that its concentration was adjusted to 8 mass %. After that, 7.4 ml of pyridine and 3.8 ml of acetic anhydride were added to the diluted product, and the mixture was stirred at room temperature for 1 hour. Further, the mixture was stirred for 4 hours while being heated to from 60° C. to 70° C. in an oil bath. The polymerization solution was reprecipitated in methanol, and the polymer was removed, followed by washing in methanol several times. After the washed product had been dried at 60° C. for 24 hours, a polyimide in a white to pale yellow powder form was obtained.

The resultant polyimide was dissolved in cyclohexanone so that its solid content concentration was 2.5 mass %. Thus, a coating liquid 42a was obtained.

### (Coating Liquid 43a for Forming Third Layer)

1-Propoxy-2-propanol was added to 200 g of an isopropyl alcohol dispersion of hollow silica particles (THRULYA 4310 manufactured by JGC Catalysts and Chemicals Ltd., average particle diameter: about 60 nm, shell thickness: about 12 nm, solid content concentration: 20.5 mass %) to adjust the solid content concentration to 3.7 mass %.

The silica sol 1 was added to the resultant so that a mass ratio between the hollow silica particles and the silica sol component was 100:11. Further, the materials were mixed and stirred at room temperature for 2 hours to provide a coating liquid 43a containing the hollow silica particles.

### (Formation of Antireflection Film)

After the formation of a coating film on the resin layer 2 with the coating liquid 41a, a coating film formed of the coating liquid 42a was subsequently formed without any curing of the coating film of the coating liquid 41a. Further, a coating film formed of the coating liquid 43a was subsequently formed without any curing of the coating film of the coating liquid 42a. The coating films formed of the respective coating liquids 41a, 42a, and 43a were dried and cured at room temperature for 24 hours to provide the optical element 20. The thicknesses of the respective layers of the optical element 20 were 30 nm, 27 nm, and 129 nm in order from the substrate.

### (Formation of Second Light-Shielding Film)

Next, a light-shielding film was further formed to form the protective layer 3. A paint for forming a light-shielding film (GT-7II: manufactured by Canon Chemicals Inc.) was applied onto the antireflection film obtained in the foregoing. The paint for forming a light-shielding film was continuously applied up to the flat surface 1D and the outer edge portion of the resin layer 2 so as to cover the antireflection film 4 on the boundary part 2A. The optical element 20 of Example 1 was manufactured by setting the application width of the paint from the boundary part 2A to 0.3 mm, that is, setting the width of the laminated region R1 to 0.3 mm, and setting the inner diameter of the protective layer 3 to 25 mm. The ratio of the width of the laminated region R1 where the protective layer 3 was laminated to the radius of the lens of Example 1 was 2.0%. The optical element 20 of Example 1 was loaded into the temperature cycle tester, and the optical element 20 after the test was evaluated for its appearance. As a result, no abnormality, such as a crack or peeling, was found in the antireflection film 4.

### Example 2

The optical element 20 of Example 2 was manufactured in the same manner as in Example 1 except that the first layer 41 was not formed as the antireflection film. As a result of the evaluation of the optical element 20 of Example 2, a microcrack at such a level as to cause no problem with the optical performance of the optical element occurred in the boundary part 2A.

### Example 3

The optical element 20 of Example 3 was manufactured in the same manner as in Example 1 except that none of the first layer 41 and the second layer 42 was formed as the antireflection film. As a result of the evaluation of the optical element 20 of Example 3, a microcrack at such a level as to cause no problem with the optical performance of the optical element occurred in the boundary part.

### Comparative Example 1

The optical element 20 of Comparative Example 1 was manufactured in the same manner as in Example 1 except that a hard coat film for plastic (PHC) was used as the antireflection film instead of the porous layer. The PHC was obtained by laminating the following plurality of metal oxide layers in order from its resin layer side through use of a vacuum deposition method:
first layer: Al₂O₃, film thickness: 500 nm;
second layer: SiO₂, film thickness: 30 nm;
third layer: ZrO₂, film thickness: 80 nm;
fourth layer: SiO₂, film thickness: 30 nm;
fifth layer: ZrO₂, film thickness: 180 nm; and
sixth layer: SiO₂, film thickness: 180 nm.

As a result of the evaluation of the optical element 20 of Comparative Example 1, a crack occurred in the boundary part 2A, and peeling occurred in the antireflection film.

### Comparative Example 2

The optical element 20 of Comparative Example 2 was manufactured in the same manner as in Comparative Example 1 except that the second light-shielding film 11 was not formed, that is, the protective layer 3 was not formed. As a result of the evaluation of the optical element 20 of Comparative Example 2, a crack occurred in the boundary part 2A, and peeling occurred in the antireflection film.

### Example 4

The optical element 20 of Example 4 was manufactured in the same manner as in Example 1 except that in the formation of the second light-shielding film 11, the protective layer 3 was formed so that the application width of the paint for forming a light-shielding film was 0.15 mm, that is, the width of the laminated region R1 was set to 0.15 mm. The ratio of the application width of the protective layer 3 to the radius of the lens of Example 4 was 1.0%. As a result of the evaluation of the optical element 20 of Example 4, a microcrack at such a level as to cause no problem with the optical performance of the optical element occurred in the boundary part 2A.

### Example 5

The optical element 20 of Example 5 was manufactured in the same manner as in Example 1 except that in the formation of the second light-shielding film 11, the protective layer 3 was formed so that the application width of the paint for forming a light-shielding film was 0.6 mm, that is, the width of the laminated region R1 was set to 0.6 mm. The ratio of the application width of the protective layer 3 to the radius of the lens of Example 4 was 4.0%. As a result of the evaluation of the optical element 20 of Example 5, no abnormality, such as a crack or peeling, was found in the antireflection film 4.

### Example 6

The optical element 20 of Example 6 was manufactured in the same manner as in Example 1 except that in the formation of the second light-shielding film 11, the protective layer 3 was formed so that the application width of the paint for forming a light-shielding film was 2.3 mm, that is, the width of the laminated region R1 was set to 2.3 mm. The ratio of the application width of the protective layer 3 to the radius of the lens of Example 6 was 15.0%. As a result of the evaluation of the optical element 20 of Example 6, no abnormality, such as a crack or peeling, was found in the antireflection film 4.

### Example 7

The optical element 20 of Example 7 was manufactured in the same manner as in Example 5 except that in the formation of the first light-shielding film 11, the buffer layer 5 was formed so that the width of the paint for forming a light-shielding film was 0.3 mm, that is, the width of the laminated region R2 was set to 0.3 mm.

As a result of the evaluation of the optical element 20 of Example 7, no abnormality, such as a crack or peeling, was found in the antireflection film 4.

### Example 8

The optical element 20 of Example 8 was manufactured in the same manner as in Example 7 except that in the formation of the second light-shielding film 11, the protective layer 3 was formed so that the application width of the paint for forming a light-shielding film was 0.1 mm, that is, the width of the laminated region R1 was set to 0.1 mm. The ratio of the application width of the protective layer 3 to the radius of the lens of Example 8 was 0.7%. As a result of the evaluation of the optical element 20 of Example 8, a microcrack at such a level as to cause no problem with the optical performance of the optical element occurred in the boundary part 2A.

### Example 9

The optical element 20 of Example 9 was manufactured in the same manner as in Example 1 except that in the formation of the second light-shielding film 11, the application thickness of the paint for forming a light-shielding film was set to 20 μm, that is, the thickness of the protective layer 3 was set to 20 μm. As a result of the evaluation of the optical element 20 of Example 9, no abnormality, such as a crack or peeling, was found in the antireflection film 4.

### Example 10

The optical element 20 of Example 10 was manufactured in the same manner as in Example 9 except that in the formation of the first light-shielding film 11, the application thickness of the paint for forming a light-shielding film was set to 10 μm, that is, the thickness of the buffer layer 5 was set to 10 μm. As a result of the evaluation of the optical element 20 of Example 9, no abnormality, such as a crack or peeling, was found in the antireflection film 4.

### Example 11

The optical element 20 of Example 11 was manufactured in the same manner as in Example 1 except that in the formation of the second light-shielding film 11, the application thickness of the paint for forming a light-shielding film was set to 2 μm, that is, the thickness of the protective layer 3 was set to 2 μm. As a result of the evaluation of the optical element 20 of Example 11, a microcrack at such a level as to cause no problem with the optical performance of the optical element occurred in the boundary part 2A.

### Example 12

The optical element 10 of Example 12 was manufactured in the same manner as in Example 1 except that the first light-shielding film 11 was not formed, that is, the buffer layer 5 was not formed. As a result of the evaluation of the optical element 10 of Example 12, a microcrack at such a level as to cause no problem with the optical performance of the optical element occurred in the boundary part 2A.

### Example 13

The optical element 10 of Example 13 was manufactured in the same manner as in Example 7 except that the first light-shielding film 11 was not formed, that is, the buffer layer 5 was not formed. As a result of the evaluation of the optical element 10 of Example 13, a microcrack at such a level as to cause no problem with the optical performance of the optical element occurred in the boundary part 2A.

### Example 14

The optical element 10 of Example 14 was manufactured in the same manner as in Example 6 except that the first light-shielding film 11 was not formed, that is, the buffer layer 5 was not formed. As a result of the evaluation of the optical element 10 of Example 14, a microcrack at such a level as to cause no problem with the optical performance of the optical element occurred in the boundary part 2A.

### Comparative Example 3

The optical element 10 of Comparative Example 3 was manufactured in the same manner as in Comparative Example 1 except that the first light-shielding film 11 was not formed, that is, the buffer layer 5 was not formed. As a result of the evaluation of the optical element 10 of Comparative Example 3, a crack occurred in the boundary part 2A, and peeling occurred in the antireflection film 4.

### Example 15

The optical element 20 of Example 15 was manufactured in the same manner as in Example 1 except that the protective layer 3 was formed by using an epoxy resin having no light-shielding performance instead of the paint for forming a light-shielding film. As a result of the evaluation of the optical element 20 of Example 15, no abnormality, such as a crack or peeling, was found in the antireflection film 4.

### Example 16

The optical element 20 of Example 16 was manufactured in the same manner as in Example 1 except that: the mold 6 different from the mold 6 used in Example 1 in shape corresponding to the aspherical shape of the resin layer 2 was used; and a thickness deviation ratio was set to 5. As a result of the evaluation of the optical element 20 of Example 16, a microcrack at such a level as to cause no problem with the optical performance of the optical element occurred in the boundary part 2A.

### Example 17

The optical element 20 of Example 17 was manufactured in the same manner as in Example 1 except that: the mold 6 different from the mold 6 used in Example 1 in shape corresponding to the aspherical shape of the resin layer 2 was used; and a thickness deviation ratio was set to 4. As a result of the evaluation of the optical element 20 of Example 17, no abnormality, such as a crack or peeling, was found in the antireflection film 4.

### Example 18

The optical element 10 of Example 18 was manufactured in the same manner as in Example 17 except that the first light-shielding film 11 was not formed, that is, the buffer layer 5 was not formed. As a result of the evaluation of the optical element 10 of Example 18, no abnormality, such as a crack or peeling, was found in the antireflection film 4.

### Comparative Example 4

The optical element 20 of Comparative Example 4 was manufactured in the same manner as in Comparative Example 1 except that: the mold 6 different from the mold 6 used in Example 1 in shape corresponding to the aspherical shape of the resin layer 2 was used; and a thickness deviation ratio was set to 4. As a result of the evaluation of the optical element 20 of Comparative Example 4, a crack occurred in the boundary part 2A, and peeling occurred in the antireflection film 4.

### Comparative Example 5

The optical element 20 of Comparative Example 5 was manufactured in the same manner as in Example 1 except that the second light-shielding film 11 was not formed, that is, the protective layer 3 was not formed. As a result of the evaluation of the optical element 20 of Comparative Example 5, a crack occurred in the boundary part 2A, and peeling occurred in the antireflection film.

### Example 19

A resin composition containing 17 parts by weight of 3-phenoxybenzyl acrylate, 26 parts by weight of 9,9-bis[4-(2-acryloyloxyethoxy)phenyl]fluorene, 55 parts by weight of ethoxylated bisphenol A diacrylate, and 2 parts by weight of a polymerization initiator diphenyl(2,4,6-trimethylbenzoyl)phosphine oxide was used as the resin composition 2a.

The optical element 20 of Example 19 was manufactured in the same manner as in Example 1. As a result of the evaluation of the optical element 20 of Example 19, no abnormality, such as a crack or peeling, was found in the antireflection film 4.

The respective physical properties and evaluation results of the respective optical elements of Examples and Comparative Examples are summarized in Tables 1-1 to 1-3 shown below.

In Tables 1-1 to 1-3, P0 and P1 indicate positions corresponding to the center P0 of the optical surface 1C and the point P1 at which the resin layer 2 has the maximum thickness, which are illustrated in each of FIG. 1, respectively. The point P1 is a point apart by 10 mm from the center P0 in a radial direction of the optical surface 1C.

It is understood from Tables 1-1 to 1-3 that the optical elements 10 of Examples 1 to 19 is superior to the optical elements of Comparative Examples 1 to 5.

TABLE 1-1

| | | | | Buffer layer | |
|---|---|---|---|---|---|
| | | | Buffer | application | Thickness |
| | | Buffer | layer | width | of resin |
| | Buffer | layer | thickness | (R2 width) | part P0 |
| | layer | material | [μm] | [μm] | [mm] |
| Example 1 | Present | Light- | 5 | 100 | 30 |
| | | shielding | | | |
| | | film | | | |
| Example 2 | Present | Light- | 5 | 100 | 30 |
| | | shielding | | | |
| | | film | | | |
| Example 3 | Present | Light- | 5 | 100 | 30 |
| | | shielding | | | |
| | | film | | | |
| Comparative | Present | Light- | 5 | 100 | 30 |
| Example 1 | | shielding | | | |
| | | film | | | |
| Comparative | Present | Light- | 5 | 100 | 30 |
| Example 2 | | shielding | | | |
| | | film | | | |
| Example 4 | Present | Light- | 5 | 100 | 30 |
| | | shielding | | | |
| | | film | | | |
| Example 5 | Present | Light- | 5 | 100 | 30 |
| | | shielding | | | |
| | | film | | | |
| Example 6 | Present | Light- | 5 | 100 | 30 |
| | | shielding | | | |
| | | film | | | |
| Example 7 | Present | Light- | 5 | 300 | 30 |
| | | shielding | | | |
| | | film | | | |
| Example 8 | Present | Light- | 5 | 300 | 30 |
| | | shielding | | | |
| | | film | | | |
| Example 9 | Present | Light- | 5 | 100 | 30 |
| | | shielding | | | |
| | | film | | | |
| Example 10 | Present | Light- | 10 | 100 | 30 |
| | | shielding | | | |
| | | film | | | |
| Example 11 | Present | Light- | 5 | 100 | 30 |
| | | shielding | | | |
| | | film | | | |
| Example 12 | Absent | — | — | — | 30 |
| Example 13 | Absent | — | — | — | 30 |
| Example 14 | Absent | — | — | — | 30 |
| Comparative | Absent | — | — | — | 30 |
| Example 3 | | | | | |
| Example 15 | Present | Light- | 5 | 100 | 30 |
| | | shielding | | | |
| | | film | | | |
| Example 16 | Present | Light- | 5 | 100 | 50 |
| | | shielding | | | |
| | | film | | | |
| Example 17 | Present | Light- | 5 | 100 | 50 |
| | | shielding | | | |
| | | film | | | |
| Example 18 | Absent | — | — | — | 50 |
| Example 19 | Present | Light- | 5 | 100 | 30 |
| | | shielding | | | |
| | | film | | | |
| Comparative | Present | Light- | 5 | 100 | 50 |
| Example 4 | | shielding | | | |
| | | film | | | |
| Comparative | Present | Light- | 5 | 100 | 30 |
| Example 5 | | shielding | | | |
| | | film | | | |

TABLE 1-2

| | | Thickness | | |
|---|---|---|---|---|
| | | deviation | | |
| | Thickness | ratio of | | |
| | of resin | optical | Anti- | |
| | part P1 | element | reflection | Protective |
| | [mm] | P1/P0 | film | layer |
| Example 1 | 300 | 10 | Three- | Present |
| | | | layer ASC | |
| Example 2 | 300 | 10 | Two- | Present |
| | | | layer ASC | |
| Example 3 | 300 | 10 | Single- | Present |
| | | | layer ASC | |
| Comparative | 300 | 10 | PHC | Present |
| Example 1 | | | | |
| Comparative | 300 | 10 | PHC | Absent |
| Example 2 | | | | |
| Example 4 | 300 | 10 | Three- | Present |
| | | | layer ASC | |
| Example 5 | 300 | 10 | Three- | Present |
| | | | layer ASC | |
| Example 6 | 300 | 10 | Three- | Present |
| | | | layer ASC | |
| Example 7 | 300 | 10 | Three- | Present |
| | | | layer ASC | |
| Example 8 | 300 | 10 | Three- | Present |
| | | | layer ASC | |
| Example 9 | 300 | 10 | Three- | Present |
| | | | layer ASC | |
| Example 10 | 300 | 10 | Three- | Present |
| | | | layer ASC | |
| Example 11 | 300 | 10 | Three- | Present |
| | | | layer ASC | |
| Example 12 | 300 | 10 | Three- | Present |
| | | | layer ASC | |
| Example 13 | 300 | 10 | Three- | Present |
| | | | layer ASC | |
| Example 14 | 300 | 10 | Three- | Present |
| | | | layer ASC | |
| Comparative | 300 | 10 | PHC | Present |
| Example 3 | | | | |
| Example 15 | 300 | 10 | Three- | Present |
| | | | layer ASC | |
| Example 16 | 250 | 5 | Three- | Present |
| | | | layer ASC | |
| Example 17 | 200 | 4 | Three- | Present |
| | | | layer ASC | |
| Example 18 | 200 | 4 | Three- | Present |
| | | | layer ASC | |
| Example 19 | 300 | 10 | Three- | Present |
| | | | layer ASC | |
| Comparative | 200 | 4 | PHC | Present |
| Example 4 | | | | |
| Comparative | 300 | 10 | Three- | Absent |
| Example 5 | | | layer ASC | |

TABLE 1-3

| | | | Protective | | |
|---|---|---|---|---|---|
| | | | layer | | |
| | | Protective | application | | |
| | Protective | layer | width | | |
| | layer | thickness | (R1 width) | Coating | |
| | material | [μm] | [μm] | ratio | Evaluation |
| Example 1 | Light- | 10 | 300 | 2.0% | A |
| | shielding | | | | |
| | film | | | | |
| Example 2 | Light- | 10 | 300 | 2.0% | B |
| | shielding | | | | |
| | film | | | | |
| Example 3 | Light- | 10 | 300 | 2.0% | B |
| | shielding | | | | |
| | film | | | | |
| Comparative | Light- | 10 | 300 | 2.0% | C |
| Example 1 | shielding | | | | |
| | film | | | | |
| Comparative | — | — | 300 | 2.0% | C |
| Example 2 | | | | | |
| Example 4 | Light- | 10 | 150 | 1.0% | B |
| | shielding | | | | |
| | film | | | | |
| Example 5 | Light- | 10 | 600 | 4.0% | A |
| | shielding | | | | |
| | film | | | | |
| Example 6 | Light- | 10 | 2,250 | 15.0% | A |
| | shielding | | | | |
| | film | | | | |
| Example 7 | Light- | 10 | 600 | 4.0% | A |
| | shielding | | | | |
| | film | | | | |
| Example 8 | Light- | 10 | 100 | 0.7% | B |
| | shielding | | | | |
| | film | | | | |
| Example 9 | Light- | 20 | 300 | 2.0% | A |
| | shielding | | | | |
| | film | | | | |
| Example 10 | Light- | 20 | 300 | 2.0% | A |
| | shielding | | | | |
| | film | | | | |
| Example 11 | Light- | 2 | 300 | 2.0% | B |
| | shielding | | | | |
| | film | | | | |
| Example 12 | Light- | 10 | 300 | 2.0% | B |
| | shielding | | | | |
| | film | | | | |
| Example 13 | Light- | 10 | 600 | 4.0% | B |
| | shielding | | | | |
| | film | | | | |
| Example 14 | Light- | 10 | 2,250 | 15.0% | B |
| | shielding | | | | |
| | film | | | | |
| Comparative | Light- | 10 | 300 | 2.0% | C |
| Example 3 | shielding | | | | |
| | film | | | | |
| Example 15 | Epoxy | 10 | 300 | 2.0% | A |
| Example 16 | Light- | 10 | 300 | 2.0% | B |
| | shielding | | | | |
| | film | | | | |
| Example 17 | Light- | 10 | 300 | 2.0% | A |
| | shielding | | | | |
| | film | | | | |
| Example 18 | Light- | 10 | 300 | 2.0% | A |
| | shielding | | | | |
| | film | | | | |
| Example 19 | Light- | 10 | 300 | 2.0% | A |
| | shielding | | | | |
| | film | | | | |
| Comparative | Light- | 10 | 300 | 2.0% | C |
| Example 4 | shielding | | | | |
| | film | | | | |
| Comparative | — | — | — | — | C |
| Example 5 | | | | | |

According to the present disclosure, the optical element having excellent environmental durability, and the method of manufacturing the optical element can be provided.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-217349, filed Dec. 12, 2024, and Japanese Patent Application No. 2024-230862, filed Dec. 26, 2024, which are hereby incorporated by reference herein in their entirety.

What is claimed is:

1. An optical element comprising:
a substrate;
a resin layer arranged on a surface of the substrate so as to have a diameter smaller than a diameter of the substrate;
an antireflection film configured to cover at least a boundary part between the substrate and the resin layer; and
a protective layer,
wherein the antireflection film includes a porous layer containing inorganic compound particles, and the protective layer is arranged on the boundary part.

2. The optical element according to claim 1, wherein the protective layer has a thickness of 1 μm or more and 100 μm or less.

3. The optical element according to claim 1, wherein the protective layer is a resin having an elastic modulus of 200 MPa or more and 4,000 MPa or less.

4. The optical element according to claim 1, wherein the inorganic compound particles are silica particles.

5. The optical element according to claim 4, wherein the silica particles are one of hollow silica particles or chain-like silica particles.

6. The optical element according to claim 1, wherein the inorganic compound particles each have a particle diameter of 15 nm or more and 300 nm or less.

7. The optical element according to claim 1,
wherein the antireflection film includes a first layer, a second layer, and a third layer in the stated order from a substrate side, and
wherein the third layer is the porous layer, and one of the first layer or the second layer is an organic layer and another thereof is an inorganic compound layer.

8. The optical element according to claim 1, wherein a width of a laminated region R₁ where the protective layer covers the resin layer is 1% or more and 15% or less of a radius of the resin layer.

9. The optical element according to claim 1, wherein a laminated region R₁ where the protective layer covers the resin layer has a width of 0.05 mm or more and 3 mm or less.

10. The optical element according to claim 1, wherein the protective layer is a light-shielding film.

11. The optical element according to claim 1, further comprising a buffer layer between the substrate and the resin layer in an outer edge portion of the resin layer.

12. The optical element according to claim 11, wherein the buffer layer is free from existing beyond a laminated region R₂.

13. The optical element according to claim 11, wherein a thickness of the protective layer is larger than a thickness of the buffer layer.

14. The optical element according to claim 11, wherein the buffer layer is a light-shielding film.

15. The optical element according to claim 11, wherein the protective layer and the buffer layer include the same material.

16. The optical element according to claim 1, wherein a maximum thickness of the resin layer is 5 times or more as large as a center thickness of the resin layer.

17. Optical equipment comprising:
a housing; and
an optical system including at least one lens arranged inside the housing,
wherein the at least one lens is the optical element of claim 1.

18. An image pickup apparatus comprising:
a housing;
an optical system including at least one lens arranged inside the housing; and
an image pickup device configured to receive light that has passed through the optical system,
wherein the at least one lens is the optical element of claim 1.

19. A method of manufacturing an optical element comprising:
a filling step of filling a space between a substrate and a mold with a resin composition;
a curing step of curing the resin composition to form the resin layer;
a mold release step of releasing the resin layer from the mold;
an antireflection film-forming step of forming an antireflection film on a surface of the resin layer;
a light-shielding film-forming step of forming a light-shielding film configured to cover part of the antireflection film; and
a step of obtaining the optical element of claim 1.

20. The method of manufacturing an optical element according to claim 19, wherein a light-shielding film configured to cover a side surface of the substrate and part of one surface of the substrate is formed.
